(19) United States
(12) Patent Application Publication
(10) Pub. No.: US 2013/0325545 A1
(43) Pub. Date: Dec. 5, 2013

(54) ASSESSING SCENARIO-BASED RISKS

(71) Applicants: Olga Mordvinova, Heidelberg (DE); Maxym Gerashchenko, Heidelberg (DE)

(72) Inventors: Olga Mordvinova, Heidelberg (DE); Maxym Gerashchenko, Heidelberg (DE)

(73) Assignee: SAP AG, Walldorf (DE)

(21) Appl. No.: 13/487,373

(22) Filed: Jun. 4, 2012

(51) Int. Cl. G06Q 10/06

(52) U.S. Cl. 705/7.28

(57) ABSTRACT

Techniques for managing risks of a business enterprise include identifying a threat to a business enterprise; identifying, based on the threat, a plurality of business enterprise assets and associated impacts; determining a plurality of threat scenarios, each threat scenario including a qualitative probability and a qualitative impact; assigning a quantitative probability and a quantitative impact to each of the plurality of scenarios based on an evaluation of the qualitative probability and the qualitative impact in a risk matrix; determining, with a simulation model, a quantitative risk of the identified threat based on the assigned quantitative probability and quantitative impact; and preparing an output including the determined quantitative risk of the identified threat for display.

### TECHNICAL BACKGROUND

This disclosure relates to scenario-based risk assessments.

### BACKGROUND

Risk management is an important consideration for any organization. However, potential risks fall into a very diverse array of categories, including risks related to information technology (e.g., computer viruses or hackers), risks related to physical facilities (e.g., fire, flood, earthquake, or burglary), as well as legal risks (e.g., failure to comply with statutory or regulatory requirements). In addition, measures that can be taken to mitigate potential risk can frequently overlap and protect against multiple risks, even across different categories. For example, a security system added to protect a file or web server from physical attacks can protect against hackers gaining physical access to the server, mitigating an information technology risk, as well as protect against burglaries, mitigating a physical facilities risk.

Additionally, the impact of a threat on an organization can depend on various scenarios. For example, collaborative analysis functionality enables identification of several estimations for threat parameters from additional experts. Nevertheless, the risk manager has to decide which values for probability and impact has to be used, thus limiting the risk assessment to a single scenario. All other threat probability and impact related information are lost. The use of direct evaluation of threat probability and impact values, together with the missing information about the risk distribution, and the restriction in machine-aided processing of additional risk information can lead to potential faults.

### SUMMARY

This disclosure describes general embodiments of systems, methods, apparatus, and computer-readable media for managing risks of a business enterprise that include identifying a threat to a business enterprise; identifying, based on the threat, a plurality of business enterprise assets and associated impacts; determining a plurality of threat scenarios, each threat scenario including a qualitative probability and a qualitative impact; assigning a quantitative probability and a quantitative impact to each of the plurality of scenarios based on an evaluation of the qualitative probability and the qualitative impact in a risk matrix; determining, with a simulation model, a quantitative risk of the identified threat based on the assigned quantitative probability and quantitative impact; and preparing an output including the determined quantitative risk of the identified threat for display.

In a first aspect combinable with any of the general embodiments, the simulation model includes a Monte Carlo simulation model.

In a second aspect combinable with any of the previous aspects, determining, with a simulation model, a quantitative risk of the identified threat based on the assigned quantitative probability and quantitative impact includes executing the Monte Carlo simulation model a specified plurality of simulations.

A third aspect combinable with any of the previous aspects includes receiving, from a user, one or more of the specified plurality of simulations for the Monte Carlo simulation model; a specified number of impact intervals for the quantitative risk; or a threat occurrence value.

In a fourth aspect combinable with any of the previous aspects, the determined quantitative risk includes one or more of a risk probability associated with a particular one of the impact intervals, a monetary impact associated with the particular one of the impact intervals, or a maximum quantitative risk value.

In a fifth aspect combinable with any of the previous aspects, determining a plurality of threat scenarios includes correlating one or more of the plurality of business enterprise assets with one or more of the associated impacts.

A sixth aspect combinable with any of the previous aspects includes identifying a plurality of asset protection measures.

In a seventh aspect combinable with any of the previous aspects, the associated impacts are based, at least in part, on the identified plurality of business enterprise assets and protection measures.

In an eighth aspect combinable with any of the previous aspects, identifying a threat to a business enterprise includes receiving, through a form interface, the threat from a business enterprise risk manager.

In a ninth aspect combinable with any of the previous aspects, identifying, based on the threat, a plurality of business enterprise assets and associated impacts includes receiving, through the form interface, the plurality of business enterprise assets and associated impacts from the business enterprise risk manager.

A tenth aspect combinable with any of the previous aspects includes receiving a modification of the assigned quantitative probability from a business enterprise risk manager.

An eleventh aspect combinable with any of the previous aspects includes determining, with the simulation model, a revised quantitative risk of the identified threat based on the modified quantitative probability and the assigned quantitative impact

Various embodiments of a scenario based risk assessment according to the present disclosure may have one or more of the following advantages. For example, the scenario based risk assessment can improve the risk evaluation of a threat; the use of value ranges from the standard risk matrix allows accurate definition of items and provable risk quantification without high effort; visualization of the risk distribution complements to increase the transparency of the risk evaluation; separated consideration of thread and scenario probabilities enables easy re-assessment life-cycle and prompt analysis of the impact distribution in case of thread occurrence.

These general and specific aspects may be implemented using a device, system or method, or any combinations of devices, systems, or methods. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions. The details of one or more embodiments are set forth in the accompanying drawings and the description below. Other features, objects, and advantages will be apparent from the description and drawings, and from the claims.

### DESCRIPTION OF DRAWINGS

FIG. 1 is a schematic illustration of a distributed computing system operable to perform scenario based risk assessment.

FIG. 2 illustrates an example a block diagram of a scenario based risk assessment infrastructure.

FIG. 3 is a flowchart depicting an example process for scenario based risk assessment.

FIG. 4 is a diagram depicting a scenario based risk assessment.

FIG. 5 is a computer-generated display of information related to the identification of risk components.

FIG. 6 is a computer-generated display of information related to the identification of possible risk scenarios.

FIG. 7 is a computer-generated display of information related to the evaluation of identified risk scenarios.

FIG. 8 is a computer-generated display of information related to the aggregation of evaluated scenarios and determination of the risk probability, impact and maximum risk value algorithm.

### DETAILED DESCRIPTION

This disclosure describes systems, methods, apparatus, and computer-readable media for scenario based risk assessment algorithms. In particular, embodiments include the components of risk representation (e.g., threat, assets, protection level and vulnerabilities) and consider many vulnerabilities and assets related to one threat that define several threat scenarios.

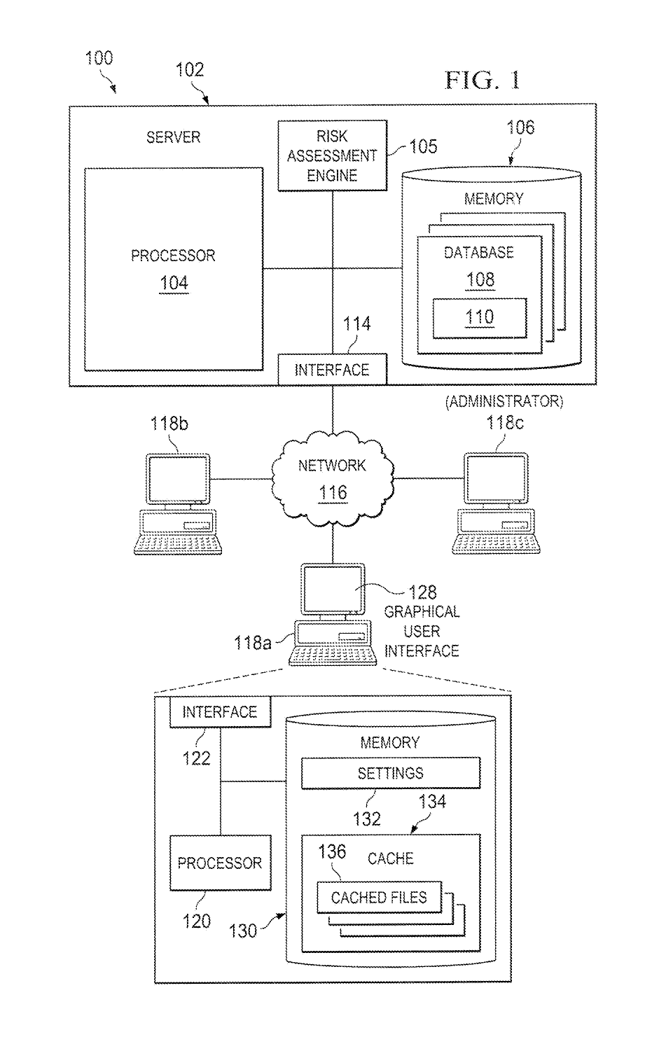

FIG. 1 is a schematic diagram of an example computing system 100, which includes or is communicably coupled with server 102 and one or more clients 118 (although only one client is illustrated in FIG. 1, a plurality of clients 118 may be included in environment 100), at least some of which communicate across network 116. In general, environment 100 depicts an example configuration of a distributed computing environment (e.g., a client-server environment). However, computing environments other than or in addition to that illustrated in FIG. 1 (e.g., stand-alone computing systems, dedicated computers or processors, cloud computing environments, and otherwise) may be utilized without departing from the scope of the present disclosure.

As illustrated in FIG. 1, the server 102 includes a risk assessment engine 105 for managing the data objects 110 included within each database 108. The risk assessment engine 105 may be executed by processor 104, and may comprise any software application or module capable of monitoring the set of data objects 110 for updates or modifications to one or more of the data objects 110 stored therein.

In some embodiments, the risk assessment engine 105 may work in connection with the server 102 to identify a threat to a business enterprise. The risk assessment engine 105 may access the database 108 to establish based on the threat, which business enterprise assets can be affected and what are the associated impacts. The risk assessment engine 105 using the processor 104 can determine the possible threat scenarios and their corresponding qualitative probability and a qualitative impact. In some embodiments, the risk assessment engine 105 includes a simulation model to quantitatively determine the risk of the identified threat, as explained in detail below. The server 102 and risk assessment engine 105 will dynamically generate a new data object 110 associated with the calculated threat estimate.

In general, server 102 is any server that includes or is communicably coupled with a database 108 that stores one or more data objects 110 where at least a portion of the data objects 110 can be communicated or transmitted to users or clients within and communicably coupled to the illustrated environment 100 of FIG. 1. In some instances, server 102 may dynamically generate or update data objects 110 “on the fly,” or when requests for those data objects 110 are received. At a high level, the server 102 comprises an electronic computing device operable to receive, transmit, process, store, or manage data and information associated with the environment 100. It will be understood that the term “server” can include any suitable component or module for providing or serving networked pages, such as networked business applications. Specifically, the server 102 illustrated in FIG. 1 is responsible for receiving requests from the client 118 for one or more data objects 110 stored at the server 102 and responding to the received requests by serving, or sending, the requested data objects 110 to the requesting client 118 via the network 116.

In addition to the client 118 illustrated in FIG. 1, requests may also be sent from internal users, external or third party customers, and automated applications, as well as other appropriate entities, individuals, systems, or computers. As used in the present disclosure, the term “computer” is intended to encompass any suitable processing device. For example, although FIG. 1 illustrates a single server 102, environment 100 can be implemented using two or more servers 102, as well as computers others than servers, including a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general-purpose computers, as well as computers without conventional operating systems. Illustrated server 102 may be adapted to execute any operating system including Linux, UNIX, Windows Server, or any other suitable operating system.

In the present embodiment, and as shown in FIG. 1, the server 102 includes an interface 114, a processor 104, a memory 106, and a risk assessment engine 105. The interface 114 is used by the server 102 for communicating with other systems in a client-server or other distributed environment (including within environment 100) connected to the network 116 (e.g., client 118, as well as other systems communicably coupled to the network 116). Generally, the interface 114 comprises logic encoded in software and/or hardware in a suitable combination and operable to communicate with the network 116. More specifically, the interface 114 may comprise software supporting one or more communication protocols associated with communications such that the network 116 or hardware is operable to communicate physical signals within and outside of the illustrated environment 100.

Generally, the network 116 facilitates wireless or wireline communications between the components of the environment 100 (i.e., between the server 102 and client 118), as well as with any other local or remote computer, such as additional clients, servers, or other devices communicably coupled to network 116 but not illustrated in FIG. 1. The network 116 is illustrated as a single network in FIG. 1, but may be a continuous or discontinuous network without departing from the scope of this disclosure, so long as at least a portion of the network 114 may facilitate communications between senders and recipients. The network 114 may be all or a portion of an enterprise or secured network, while in another instance at least a portion of the network 114 may represent a connection to the Internet. In some instances, a portion of the network 114 may be a virtual private network (VPN), such as, for example, the connection between the client 118 and the server 102.

Further, all or a portion of the network 114 can comprise either a wireline or wireless link. Example wireless links may include 802.11a/b/g/n, 802.20, WiMax, and/or any other appropriate wireless link. In other words, the network 114 encompasses any internal or external network, networks, sub-network, or combination thereof operable to facilitate communications between various computing components inside and outside the illustrated environment 100. The network 114 may communicate, for example, Internet Protocol (IP) packets, Frame Relay frames, Asynchronous Transfer Mode (ATM) cells, voice, video, data, and other suitable information between network addresses. The network 114 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, server 102 includes a processor 104. Although illustrated as a single processor 104 in FIG. 1, two or more processors may be used according to particular needs, desires, or particular embodiments of environment 100. Each processor 104 may be a central processing unit (CPU), a blade, an application specific integrated circuit (ASIC), a field-programmable gate array (FPGA), or another suitable component. Generally, the processor 104 executes instructions and manipulates data to perform the operations of server 102, often using software. Specifically, the server's processor 104 executes the functionality required to receive and respond to requests from the client 118, as well as the functionality required to update and store information associated with the plurality of data objects 110 within memory 106. Regardless of the particular embodiment, “software” may include computer-readable instructions, firmware, wired or programmed hardware, or any combination thereof on a tangible medium as appropriate. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The server 102 also includes memory 106. Memory 106 may include any memory or database module and may take the form of volatile or non-volatile memory including, without limitation, magnetic media, optical media, random access memory (RAM), read-only memory (ROM), removable media, or any other suitable local or remote memory component. Memory 106 may store various objects or data, including classes, frameworks, applications, backup data, business objects, jobs, files, file templates, database tables, repositories storing business or other dynamic information, or any other information including any parameters, variables, algorithms, instructions, rules, constraints, or references thereto relevant to the purposes of the server 102. Additionally, memory 106 may include any other appropriate data, such as VPN applications, firmware logs and policies, firewall policies, a security or access log, print or other reporting files, as well as others.

Specifically, illustrated memory 106 includes a plurality of data objects 110 (where at least some of the data objects 110 include one or more text data objects 110). Although illustrated within memory 106, some or all of the illustrated elements may be located or stored outside of memory 106 and/or server 102 (e.g., in multiple different memories and/or on multiple different servers, as well in other locations external to, but communicably coupled with, environment 100). For example, some or all of the data objects 110 may be stored remotely from server 102, and accessed separately by the client's browser 128 based on the file reference 110 received with the particular requested database 108 served by the server 102. Each data object 110 may be stored as a spreadsheet file (e.g., Microsoft Excel®), a text file, an HTML document, an eXtensible Hypertext Markup Language (XHTML) document, an XML document, or any other suitable file type that can be processed and used by a client 118 to provide a visual representation of the character strings defined by the associated file 108. In many situations, the data object 110 may include various programming languages or text implementing various formats and functions. In other words, each data object 110 may include any number of references to cacheable information and such reference may be direct or indirect as appropriate.

In addition to static content defined by the data object 110 each database 108 may include, embed, or be associated with additional dynamic content, as well as other content stored apart from the database 108 itself, wherein the associated content is defined as embedded within, or a part of, the file file's 108 source code. In those instances, in addition to the database 108 itself, additional information or data is retrieved by the client 118 in order to provide a complete visual representation of the file associated with the file 108.

In addition to the location of the data object 110, each file reference 110 may, in some embodiments, include an additional parameter that uniquely defines the current version of the associated character strings stored at the referenced location. For example, an additional parameter uniquely identifying the stored strings within the data object 110 may be a “last modified” attribute of the data object 110, defining when the data object 110 was last updated or modified. In those instances, the parameter may be defined by the date, and, in some cases, the exact time, of the last data object 110 modification. Alternatively, the unique identifier may be randomly assigned each time the data object 110 is updated or modified, such as by using a random number generator or random system entropy data collected at the time of the update or modification. In still other instances, the unique identifier or parameter may be represented as the file name of the data object 110, while in other instances, the particular version number of the data object 110 may be used. Additionally, a combination of some or all of these unique identifiers, as well as others, may be used or combined to create the unique identifier for the file reference 110.

The illustrated environment of FIG. 1 also includes one or more clients 118. Each client 118 is any computing device operable to connect or communicate at least with the server 102 and/or the network 116 using a wireline or wireless connection. Further, each client 118 includes a processor 120, an interface 122, a graphical user interface (GUI) 128, and a memory 130. In general, the client 118 comprises an electronic computing device operable to receive, transmit, process, and store any appropriate data associated with the environment 100 of FIG. 1. It will be understood that there may be any number of clients 118 associated with environment 100, as well as any number of clients 118 external to environment 100. For example, while illustrated environment 100 of FIG. 1 includes three clients (118a, 118b, and 118c), alternative embodiments of environment 100 may include a single client 118 communicably coupled to the server 102, while other embodiments may include more than the three clients 118. There may also be one or more additional clients 118 external to the illustrated portion of environment 100 that are capable of interacting with the environment 100 via the network 116. Further, the term “client” and “user” may be used interchangeably as appropriate without departing from the scope of this disclosure. For example, in some embodiments, a user may be a business enterprise risk manager that is tasked with evaluating and/or predicting possible threats, risk scenarios, and other risk-associated jobs. Moreover, while each client 118 is described in terms of being used by one user, this disclosure contemplates that many users may use one computer or that one user may use multiple computers.

As used in this disclosure, client 118 is intended to encompass a personal computer, touch screen terminal, workstation, network computer, kiosk, wireless data port, smart phone, personal data assistant (PDA), one or more processors within these or other devices, or any other suitable processing device. For example, each client 118 may comprise a computer that includes an input device, such as a keypad, touch screen, mouse, or other device that can accept information, and an output device that conveys information associated with the operation of the server 102 or the client 118, including digital data, visual information, or the GUI 128. Both the input device and the output device may include fixed or removable storage media such as a magnetic computer disk, CD-ROM, or other suitable media to both receive input from and provide output to users of the clients 118 through the display, namely the GUI 128. As indicated in FIG. 1, client 118c is specifically associated with an administrator of the illustrated environment 100. The administrator associated with client 118c can modify various settings associated with one or more of the other clients 118 (including one or more browser settings 132 associated with each client 118), server 102, and/or any suitable portion of environment 100. For example, the administrator of client 118c may be able to modify the cache timeout values associated with web browsers within each of the clients 118, as well as any settings associated with the risk assessment engine 105, such as the format and style of the parameters generated to uniquely identify the various data objects 110 stored at the server 102.

The interface 122 of each client 118 may be similar to interface 114 of the server 102 in that it may comprise logic encoded in software and/or hardware in a suitable combination and operable to communicate with the network 116. More specifically, interface 122 may comprise software supporting one or more communication protocols such that the network 116 or hardware is operable to communicate physical signals to and from the client 118.

Similarly, memory 130 of each client 118 may be similar to memory 106 of the server 102, and may include any memory or database module and take the form of volatile or non-volatile memory including, without limitation, magnetic media, optical media, random access memory (RAM), read-only memory (ROM), removable media, or any other suitable local or remote memory component. For example, memory 130 may store backup data, parameters, cookies, variables, algorithms, instructions, rules, or references thereto, as well as any other suitable data. As illustrated, memory 130 includes a set of browser settings 132, a web cache 134, and an file cache 136, each of which will be described below.

The GUI 128 comprises a graphical user interface operable to allow the user to interface with at least a portion of environment 100 for any suitable purpose, including generating a visual representation of the one or more data objects 110 received by the client 118 from the server 102, as well as to allow users at each client 118 to view those visual representations. Generally, the GUI 128 provides users with an efficient and user-friendly presentation of data provided by or communicated within the system. The term “graphical user interface,” or GUI, may be used in the singular or in the plural to describe one or more graphical user interfaces and each of the displays of a particular graphical user interface. Therefore, the GUI 128 can be any graphical user interface, such as a web browser, touch screen, or command line interface (CLI) that processes information in the environment 100 and efficiently presents the results to the user. In general, the GUI 128 may include a plurality of user interface (UI) elements such as interactive fields, pull-down lists, and buttons operable by the user at the client 118. These UI elements may be related to the functions of one or more applications executing at the client 118, such as a business application or the web browser associated with the GUI 128. In particular, the GUI 128 may be used in connection with the web browser associated with the GUI 128 to view and navigate to various files, some of which may be associated with (or the visual representation of) the data objects 110 stored in and associated with the server 102 (as illustrated in FIG. 1).

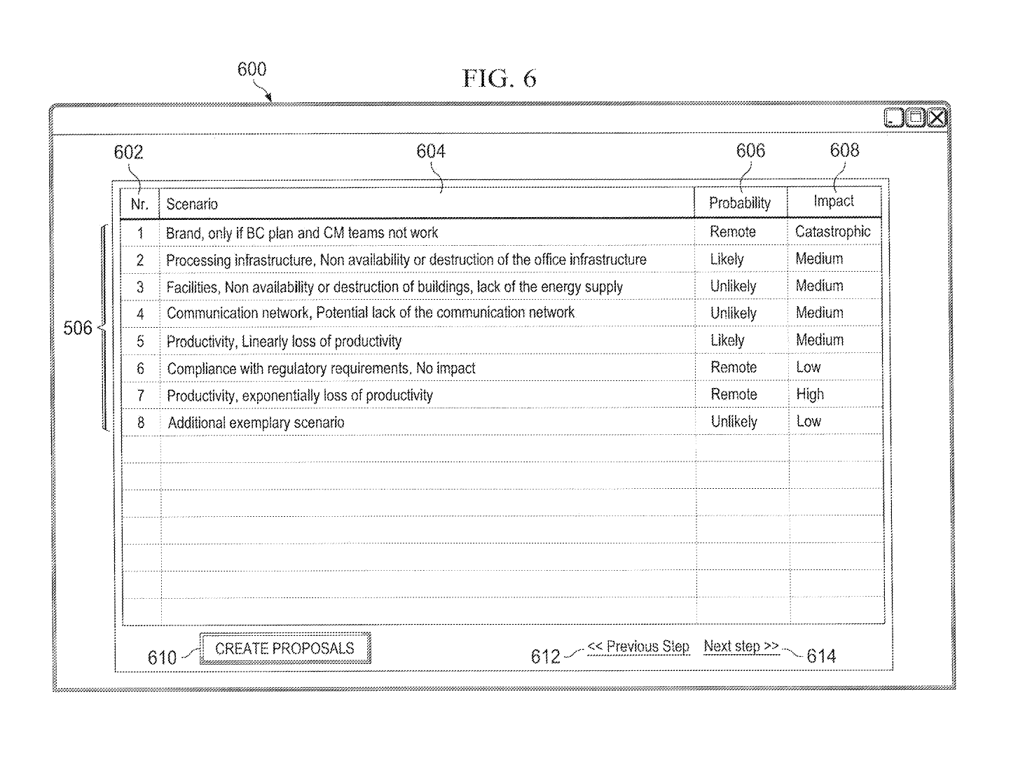

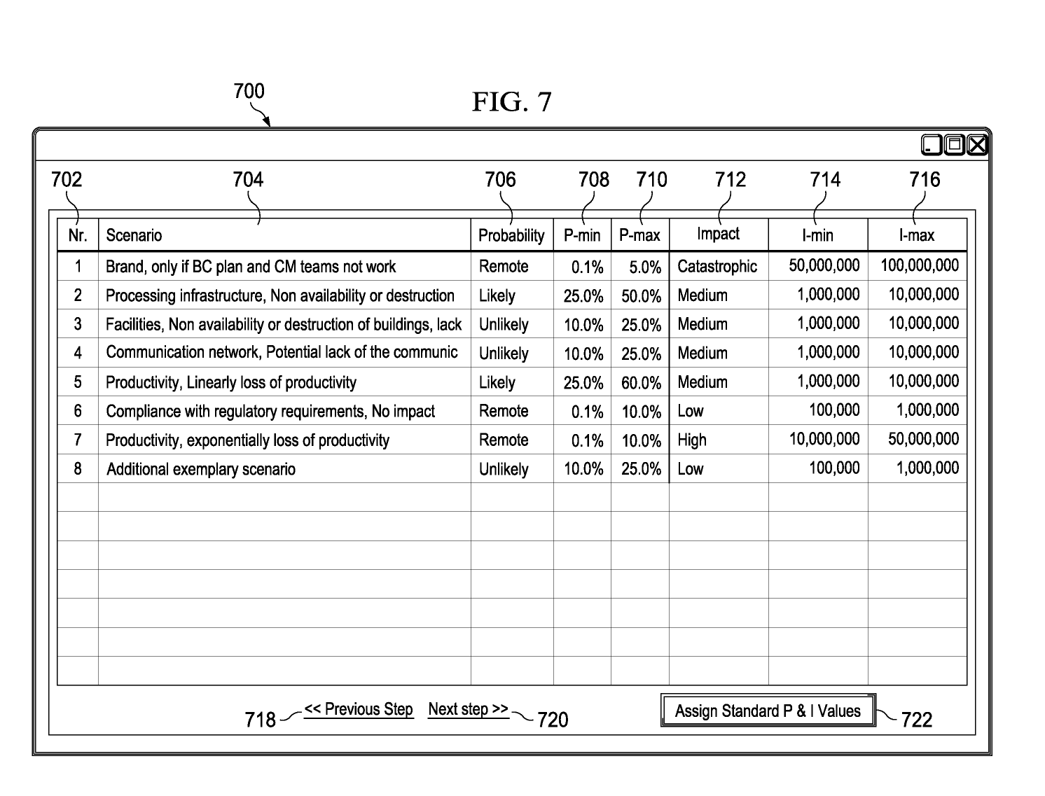

In some instances, the GUI 128 may be all or a portion of a software application, which enables the client 118 (or a user thereof) to display and interact with various types of documents which include strings and are typically located in files received from one or more servers (e.g., data objects 110 on server 102), or other computers accessible via the network 116. The strings embedded within files can be grouped and displayed through GUI 128 to enable execution of one or more risk assessment algorithms, with the risk assessment engine 105. Users of client 118 can also view output associated with risk assessment of a threat using the GUI 128. In general, the GUI 128 may display, for instance, all or part of the data objects 110, as well as one or more user interfaces, such as the example user interfaces shown in FIGS. 6-7. As illustrated in FIG. 1, the GUI 128 can connect to the server 102 via the network 116. In certain embodiments, the GUI 128 may be associated with, or may be a portion or module of, a business application, providing web browser or similar file processing and visualization functionality to the application.

Further, when the GUI 128 sends a second, later request for the same file to the server 102, the server 102 again sends a copy of the associated data object 110 to the GUI 128. After this request, however, some or the entire data object 110 may be cached at the client 118 such that additional server requests for the embedded, cacheable elements of the database 108 may not be necessary.

While FIG. 1 is described as containing or being associated with a plurality of components, not all components illustrated within the example embodiment of FIG. 1 may be utilized in each alternative embodiment of the present disclosure. Additionally, one or more of the components described herein may be located external to environment 100, while in other instances, certain components may be included within or as a portion of one or more of the other described components, as well as other components not described. Further, certain components illustrated in FIG. 1 may be combined with other components, as well as used for alternative or additional purposes in addition to those purposes described herein.

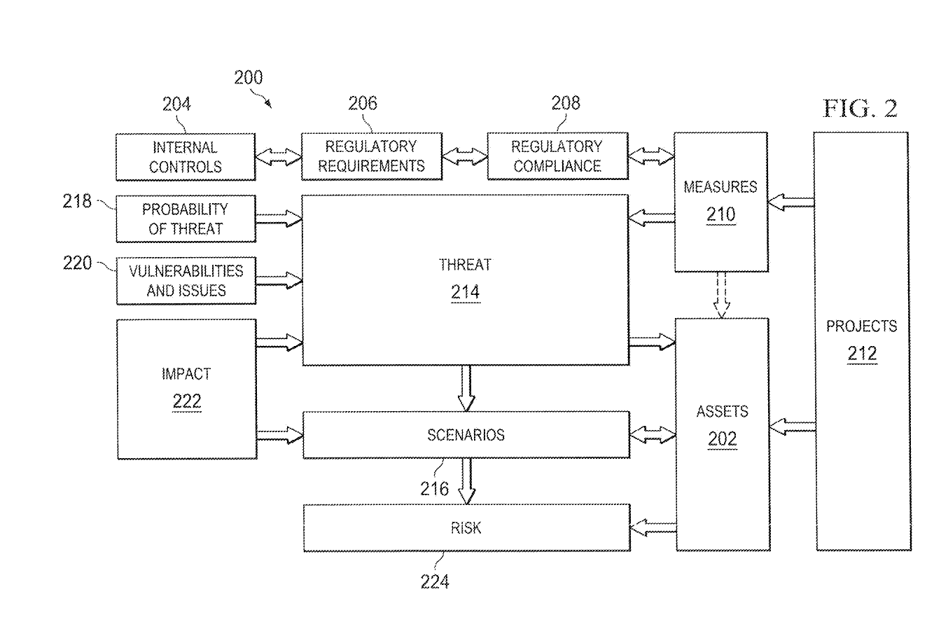

FIG. 2 illustrates a scenario based risk assessment infrastructure for an organization. The organization (e.g., a business enterprise) has assets 202. Items (tangible and/or intangible) that have value to the organization and that require protection, for instance, can be an asset 202. Examples of possible assets 202 include customer data, a server, facilities/physical plant, employees, brand value, and public image. Typically, it is desirable to keep the value of a particular asset as high as possible; alternatively, it is also desirable to keep the total cost of ownership for a particular asset as low as possible.

Vulnerabilities and issues 220 generally increase the risk 224 associated with a threat 214 and lower the value of one or more assets 202. A single vulnerability or issue 220 can lower the value of a single asset or the value of multiple assets 202 at the same time. For example, a strong earthquake at a warehouse lowers the value of the physical plant, lowers the value of any inventory damaged by the fire, and can even lower the value of employees staffed at the damaged warehouse if the organization is unable to find useful work for these employees. A different kind of incident is a flaw discovered in a product produced by the organization; the product flaw can potentially lower shareholder value as well as the public reputation of the organization. Although many incidents are not scheduled, and happen without warning, incidents can also be anticipated in advance.

In order to protect the value of assets 202, measures 210 can be implemented to protect the value of the assets 202. Examples of measures 210 include virus protections, building access controls, emergency and crisis management plans, business continuity and impact analysis, and segregation of duties. Measures can be implemented for a variety of reasons. Contractual obligations between the organization and third parties might call for particular measures. Various organization or asset specific security standards specify measures that may have to be implemented. The organization's own policies can dictate other measures.

In some embodiments, regulations 208 set forth various regulatory requirements 206 that impact the measures 210 taken by the organization. For example, the Sarbanes-Oxley Act of 3002 (SOX) of the United States sets forth legal requirements that potentially require that one or more measures 210 be undertaken by the organization in order to comply with the SOX rules and regulations. Similarly, the KonTraG laws of Germany set forth legal requirements that might require other measures in order to comply with the KonTraG regulations. The organization's internal controls 204 help to ensure that measures 210 are implemented to allow the organization to comply with the various regulations 208.

In some embodiments, projects 212 undertaken by the organization can affect the quality and effectiveness of measures 210, as well as affect assets 202. Projects 212 can include business projects undertaken by the organization; these business projects may not be intended to affect the measures 210, but can often have either a positive or a negative impact on at least one, and typically more than one, measure 210. For example, a business project designed to expand operations to a new country might require additional measures to be put into place in order to comply with local laws. However, this same business project can also have a negative impact on other measures, e.g., if the organization leases a new building that does not have the same level of building access controls as the rest of the organization's facilities. In addition, projects can influence assets; for example, an asset might be shifted to a different location, or the total cost to own an asset increases because of the particular project.

Projects 212 can also include security projects that are specifically designed to have a positive impact on one or more measures 210. For example, a security project to install a fire sprinkler system adds an additional measure to the measures 210 that protect the organization's assets 202—in this case, the sprinkler system helps protect the physical plant from the threat of fire.

In some embodiments, the risk 224 of a threat 214 also depends on vulnerabilities and issues 220. The vulnerability assessment considers the potential impact 212 of a threat as well as the vulnerability of the facility/location to a threat. In some embodiments, the description of existing vulnerabilities and issues can be linked to protection measures 210 and indicate measures with low efficiency. In some embodiments, vulnerabilities and issues can be related to external events, such as earthquakes or severe weather or internal events, such as trainings and planning. The definition of vulnerability 220 may vary greatly from facility to facility. For example, the amount of time that communication capability is impaired is an important part of a severe weather threat impact. If the facility being assessed is an Air Route Traffic Control Tower, a downtime of a few minutes may be a serious threat impact, while for a Social Security office a downtime of a few minutes would be minor threat.

In some embodiments, threats 214 include any potential incidents that would harm one or more assets 202. As will be described later, each threat has a particular probability of occurrence 218 and an associated financial impact of the threat on the assets 202. For example, the likelihood that an employee will fall ill is quite high, but the financial impact of having an employee stay home for a day or two is quite small. On the other hand, the likelihood of an earthquake is very low, but the financial impact of the earthquake would be quite high. In addition, the likelihood of a particular threat can be affected by the geographical location of the assets 202 to which the threat relates. For example, an earthquake in California is more likely than an earthquake in Germany. Thus, historical and geographical data can be used to derive the probability of a threat 218. In some embodiments, the probability of a threat could be expressed in percentage. For example the annual probability of an earthquake in Germany could be 4%. In case the threat took place, the probability of threat can be set to maximum (e.g., 100%) and the risk assessment engine 105 can be used to estimate the impact of the threat 214.

In some embodiments, the probability 218 and financial impact 222 of the threats 214 allow a risk 224 to be calculated. The risk 224 is expressed as a currency value, e.g., dollars, euros, yen, etc., and is the mathematically expected cost to the organization of all the threat scenarios 216 on the assets 202, based upon the value of the assets 202 and the likelihood of the threats 214 on the assets 202 over a particular time window. In addition, based on multiple threat scenarios 216, the measures 210, the vulnerabilities and issues 220 or both, as well as the change of risk 224 that occurs based upon the projects 212 or measures 210, the overall impact 222 of the threat 214 can be calculated.

The following is an example of the relationship between measures 210, threats 214, and assets. An organization monitors computer system access and use; this is a measure taken by the organization. This measure helps mitigate the threats 214 of hacking attacks as well as industrial espionage. Another measure implemented by the organization is building access control. The building access control helps to reduce the threat of industrial espionage as well as burglary. Finally, the organization also implements emergency and crisis management plans. Such plans can mitigate the threats of hacking attacks, industrial espionage, burglary, and natural disasters.

Further, each of these threats has a potential impact on one or more of the organization's assets 202. For example, a hacking attack could impact a computer server, or result in a breach of the organization's confidential data. Industrial espionage could also have an impact on the computer server or the organization's confidential data. The burglary might have an impact on the computer server, as well as on the server room itself. Finally, a natural disaster might have an impact on the computer server, the server room, and the employees of the organization.

Some measures might be required by various government and industry regulations 206 and 208. For example, both KonTrag and SOX include a requirement that critical organizational data be backed up. The German Data Protection Act (Deutsches Datenschutzgesetz) requires that in addition to data backup, both physical access controls and availability controls be implemented within an organization to protect confidential data.

Further, the measures 210 and assets 202 can all be affected by projects undertaken by the organization. For example, the opening of a new data center, the outsourcing of information technology (IT) services, and identity management all represent projects 212 that could impact the organization's assets 202, requiring the adjustments of the organization's measures 210.

In addition, external changes can impact the organization's measures 210 and the threats to the organization's assets 202. For example, a new threatening technology introduced by a competitor might represent a new threat, to which the organization must adapt. Other external changes might include various political events, such as the introduction of proposed legislation or a change in power after a government election. Physical changes to the environment can also have an impact on the organization; for example, if a new nuclear power plant is constructed near the organization's facilities, the organization may need to adapt its measures in order to deal with the threat that this new power plant might pose.

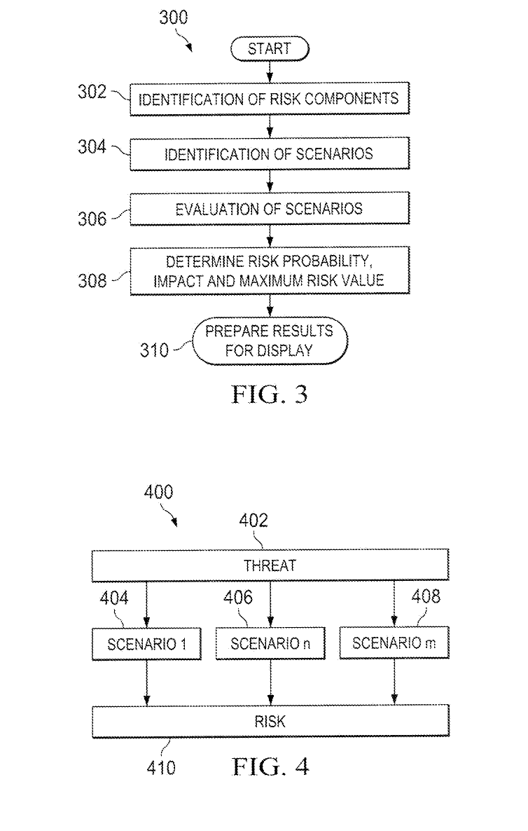

Referring now to FIG. 3, a flowchart depicting an example method 300 for scenario based risk assessment is provided. In some embodiments, for instance, method 300 may be performed, at least in part, by the risk assessment engine 105. In step 302, risk components are identified. In some embodiments, the identified risk components are risk components. For example, the risk components may be defined as the risk scope including the existing protection level, gaps and vulnerabilities, affected assets and generally expectation of the threat probability. For example, the identification of the risk components 302 can include the following activities: specification of threat which causes a particular risk and probability of this threat, description of existing protection measures, description of existing vulnerabilities and issues, description of assets potentially affected by the threat and description of possible impact for each asset and circumstances under which it could occur.

In step 304 multiple risk scenarios are identified. In some embodiments, identification of scenarios 304 is based on the previous step 302 and it can happen semi-automatically. For example, the risk assessment engine 105 can automatically generate multiple scenario proposals based on a combination of assets (202 in FIG. 2) and corresponding impact. A user (e.g., risk manager) can validate the proposed scenarios and can have an option to adjust the generated scenarios or to define new scenarios. Afterwards, the user can provide a qualitative estimation of scenario probability and impact by using standard company ranges like high, medium or low. For example, in some embodiments, a scenario probability may be considered with the assumption that a related threat has already actually occurred. An example is a high probability for building destruction in case of an earthquake over a particular magnitude in a certain geographic region.

With continued reference to FIG. 3, in step 306 the risk assessment engine 105 evaluates the scenarios. In some embodiments, the evaluation of scenarios 306 can include qualitative values and/or quantitative ranges. In some embodiments, the evaluation of scenarios 306 can use the standard range definition, used by the standard risk matrix to convert qualitative values into quantitative ranges. For example, the evaluation of scenarios 306, for transferring can convert the low impact value into 1 and 200.000 EUR impact range. In some embodiments, the user interacting with the evaluation of scenarios 306 can chose to accept the proposed standard values or to specify the quantitative ranges more (e.g., 10.000-20.000) or less (e.g., 1-300.000) accurate. This function of the method 300 may be helpful for the reassessments of scenarios 306 and enables the improvement of quality of the risk assessment by usage of smaller ranges. In some embodiments, a user can assess very uncertain risks using a less accurate value.

In step 308 the risk probability, impact and maximum risk value are determined. In some embodiments, the method 300 includes the aggregation of scenarios and determination of the risk probability, impact and maximum risk value 308. In some embodiments, the risk probability, impact and maximum risk value 308 can be determined using simulation methods (e.g., Monte Carlo simulation). In some embodiments, a user can adjust the simulation parameters and perform several simulations to get a particular view and visualization on scenario correlation. In some embodiments, the determined values can help to identify the risk impact and probability.

In some embodiments, step 308 may be performed according to the following example pseudo code:

```
Read in simulation parameters (nr_of_ranges, nr_of_experiments,
thread_occurred)
Read scenarios including data ranges
Calculate potential max impact to determine max simulation value
Round up max simulation value (e.g. 179 to 180)
Range_area = max simulation value / nr_of_ranges
Create array Range(number_of_ranges+1,3)
Set_Range(0:number_of_ranges,2)=0
// Range[x,0] is a max range value, Range[x,1] is a min range value and
used for visualization only
// Range[x,2] is used to store the nr. of experiments fitting to this range
I_max = 0
FOR 1 to nr_of_experiments
  I_experiment = 0
  FOR EACH scenario
    P_scenario = Random(P_scenario_min to P_scenario_max)
    IF threat_occurred THEN
      P_scenario= P_scenario * P_threat
    END IF
    IF Random(0.0001 to 100) <= P_scenario THEN
      I_scenario = Random(I_scenario_min to I_scenario_max)
      I_experiment = I_experiment + I_scenario
    END IF
  END FOR
  IF I_experiment > 0 THEN
    I = Int((I_experiment / Range_area) + 1)
    Range[I,2] = Range[I,2]+ 1
    IF I_experiment_> I_max THEN
      I_max = I_experiment
    END IF
  ELSE
    Range[0,2] = Range[0,2] + 1
  END IF
END FOR
```

In some embodiments, the overall risk evaluation 308 can be easily modified using adjustable parameters implemented in the method 300. For example, an adjustable parameter in the method 300 can be the probability of a threat. After a threat occurs, the probability of the threat can be adjusted to reflect the occurrence of the event to support the planning of the risk responses and to enable quick risk reassessment. Further, in some embodiments, a user may adjust a threat probability for a particular assigned qualitative probability (e.g., remote, low, high, likely, medium, and otherwise). Such a modification may, for example, also modify a determined risk probability using the risk assessment engine 105. For example, in case of an earthquake, the short-term development of the situation can be evaluated using the risk assessment engine 105 (e.g., through the method 300). In some embodiments, the risk probability, the impact and/or maximum risk value maximal risk impact can be selected for display or risk description 310.

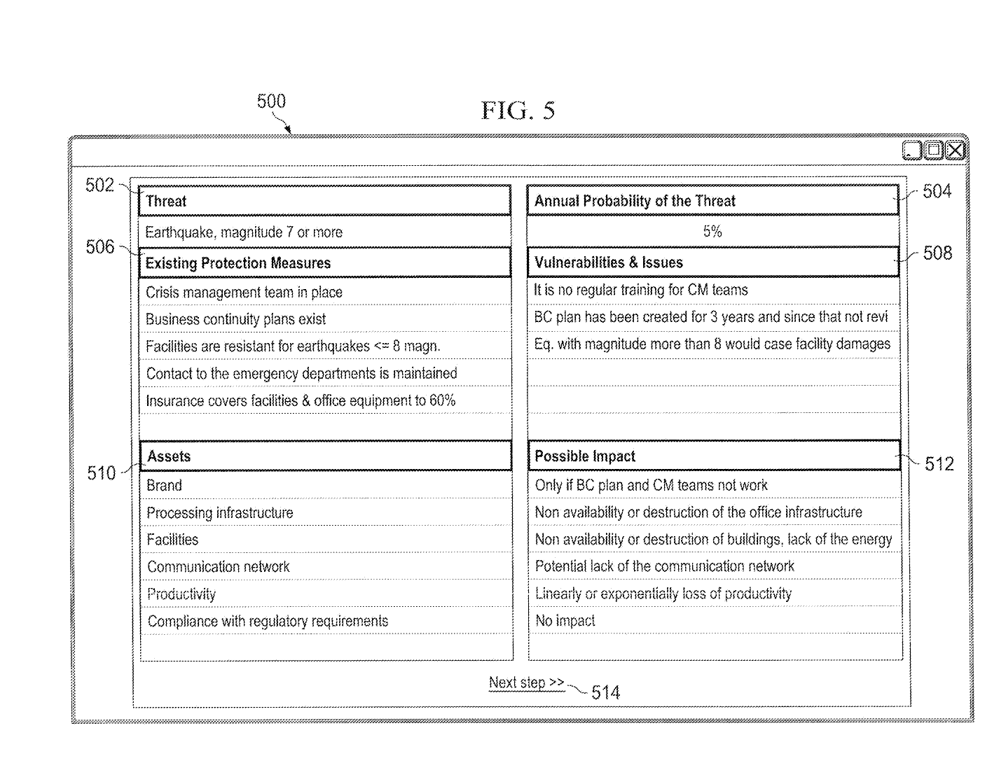

Referring now to FIG. 4, a diagram depicting an example scenario based risk assessment 400 is provided. The risk 410, in some embodiments, consists of the following components: threat, assets, protection level, and vulnerabilities. In some embodiments, the estimation of risk 410 involves the calculation of the impact and the probability of the risk occurrence.

In some instances, the risk may occur in multiple different ways, which are also known as risk scenarios (404, 406 and 408). In some embodiments, the number of scenarios can depend on the number of assets, the probability of threat, the impact of threat and/or other threat factors. Thus, each scenario may have its own probability and impact, which can be assessed more accurate than a general risk. For example, an earthquake (threat 402) can affect multiple assets, such as facilities and processing infrastructure with different impacts, such as no impact to complete destructions. Considering the measures, the vulnerabilities and issues of each asset (as illustrated by FIGS. 2 and 3), some one or more impacts (e.g., complete destruction) could be ignored, as being improbable, which limits the list to probable impacts.

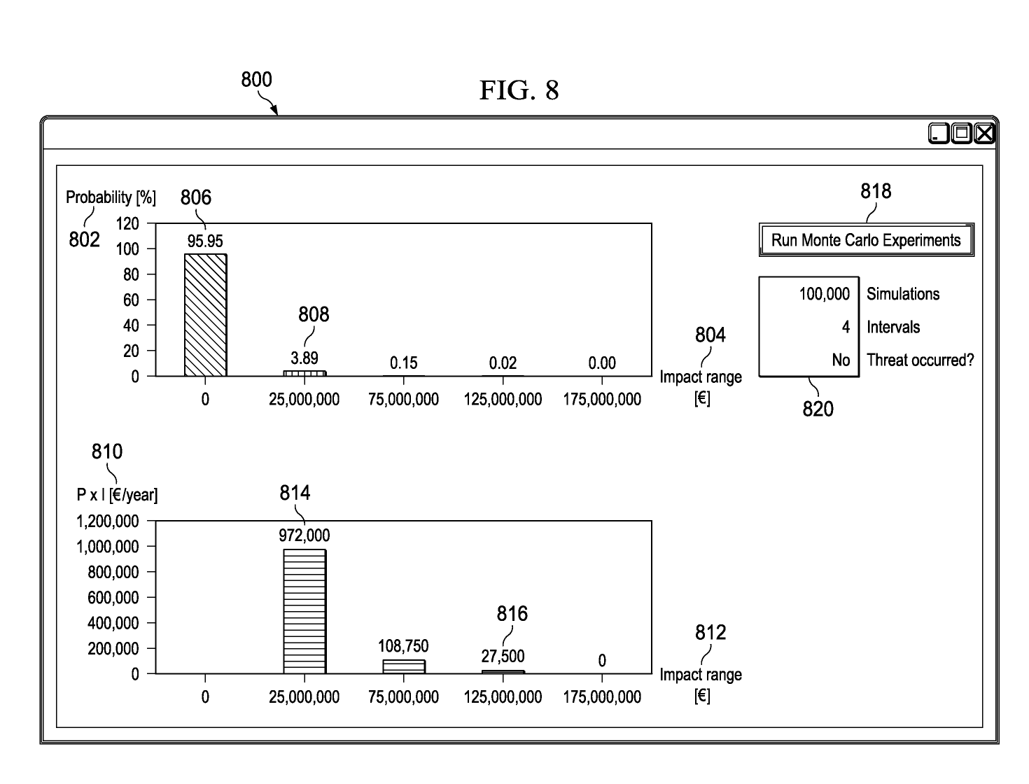

In some embodiments, the overall risk 410 is calculated as a function of all scenarios (404, 406 and 408) that can occur with a threat 402. Every risk 410 can be represented by aggregation of related scenarios (404, 406 and 408), as shown in the example process 400 and FIG. 8.

In FIG. 5, an example of a computer-generated display of information related to the identification of risk components is illustrated. FIG. 5 illustrates an example user interface 500 that may be used to manage risks to a business enterprise. Interface 500 includes a threat component 502, a threat component probability 504, an existing protection measures component 506, a vulnerabilities & issues component 508, an assets component 510 and a possible impact component 512.

The threat component 502 defines one or more threats to the business enterprise. For example, threats may include physical or natural threats, such as earthquakes.

The threat component probability 504 defines (e.g., numerically) a probability of a particular threat. For example, the probability may be an annual probability.

The existing protection measures component 506 defines the set of protection measures associated with a particular threat. For example, the existing protection measures may be syntaxes denoting procedures, contracts, classes, relationships or other actions reflecting protection against a threat.

The vulnerabilities & issues component 508 defines the set of vulnerabilities and issues associated with a particular threat. For example, the vulnerabilities & issues may be syntaxes denoting the complete or partial absence of particular procedures, contracts, classes, relationships or other actions that could offer protection against a threat.

The assets component 510 defines the set of tangible and intangible items that could be affected by a threat. For example, assets may be the brand, the processing infrastructure, the communication network, productivity and/or other items.

The possible impact component 512 defines the possible effect of a threat on a particular asset. For example, the possible impact could be a syntax including the name of an asset, and a qualitative indicator of the threat's effect derived from the corresponding protection measures, vulnerabilities and issues.

In some embodiments the scenario based risk assessment can be effectuated using a graphical user interface, which allows a user to select a threat 502. The threat 502 can be selected from a list of available threats or it can be generated by the user.

In some embodiments, the probability of a threat 504 within a time interval (e.g., within a year) can be automatically generated using historical or statistical data. This data can be retrieved from internal or external databases. For example, the annual probability of an earthquake could be derived from local seismological data.

In some embodiments, the existing protection measures 506 related to a threat 502 can be automatically selected from an internal database. The existing protection measures 506 related to a threat 502 can be created or selected by a user interacting with the computer-generated display 500. For example, a protection measure, related to an earthquake can be the existence of business continuity plans.

In some embodiments, the vulnerabilities and issues 508 related to a threat 502 can be automatically selected from an internal database. The vulnerabilities and issues 508 related to a threat 502 can be created or selected by a user interacting with the computer-generated display 500. For example, a vulnerability related to an earthquake can be related to its magnitude, being expressed as “earthquake with magnitude higher than 8 would cause facility damages”.

In some embodiments, the assets 510 related to a threat 502 can be automatically selected from an internal database considering their respective value. The assets 508 related to a threat 502 can be created or selected by a user interacting with the computer-generated display 500. The assets 510 can be both physical (e.g., machines, building, devices, etc.) and non-physical (e.g., communication network, productivity, processing infrastructure, etc.).

In some embodiments, the possible impact 512 of a threat 502 can be automatically selected from a database. The possible impact 512 of a threat 502 can be created or selected by a user interacting with the computer-generated display 500.

In some embodiments, the computer-generated display 500 can include a button 514 to allow the user to activate the successive step of the scenario-based risk assessment.

Referring to FIG. 6, a computer-generated display of identified scenarios 600 related to the identification of possible risk scenarios (e.g., step 304 in FIG. 3) is illustrated. In some embodiments, the computer-generated display of scenarios 600 can be a tabulated display, which structurally illustrates the information related to the identified scenarios.

In some embodiments, the computer-generated display of scenarios 600 can include information about the number of identified scenarios as illustrated by 602, a brief description of the scenario, 604, the probability of the scenario 606 and the impact associated to a scenario 608. The brief description of the scenario 604 could be a syntax including the name of the asset the scenario refers to and the way the threat might affect the named asset. The probability of the scenario 606 could be qualitatively described by representative terms (e.g., likely, remote and unlikely). The impact associated to a scenario 608 could be qualitatively described by representative terms (e.g., low, medium, high and catastrophic).

For example, based on the previously identified risk components, one scenario could be related to communication network, specifically addressing the potential lack of communication network (scenario 4 in FIG. 6). Derived from the existing measures to protect the communication network and the vulnerabilities of the communication network, the automatically identified probability could be ‘unlikely’ and the corresponding impact could be medium.

In some embodiments, the computer-generated display of identified scenarios 600 can include multiple control buttons (e.g., 610, 612 and 614). One control button 610 can be included in the computer-generated display 600 to allow the user to create new proposals of scenarios. One control button 612 can be included in the computer-generated display 600 to allow the user to return to the previous step to access the information related to the identification of risk components. One control button 614 can be included in the computer-generated display 600 to activate the successive step of the scenario-based risk assessment, which enables evaluation of scenarios, as described in detail in FIGS. 3 and 7.

Referring to FIG. 7, a computer-generated display for scenarios evaluation 700 is described. In some embodiments, the computer-generated display of scenarios evaluation 700 can be a tabulated display, which structurally illustrates the information necessary for the scenarios evaluation.

In some embodiments, the computer-generated display of scenarios evaluation 700 can include information about the number of scenarios that require evaluation as illustrated by 702, a brief description of the scenario, 704, the identified probability of the scenario 706, the quantitative minimum and maximum probability value of a scenario (708 and 710, respectively), the identified impact associated to a scenario 712 and the quantitative range of the impact (714 and 716). In some embodiments, the brief description of the scenario 704, the qualitative descriptors of probability of the scenario 706 and the impact associated to a scenario 712 could be the same as illustrated in the scenario identification step (FIG. 6 at 604, 606 and 608, respectively).

In some embodiments, the scenarios that are likely to occur and the scenarios that can lead to catastrophic impact can be highlighted, for example by bright colors or particular font features. The probability range (minimum probability 708 and maximum probability 710) can be automatically generated based on the qualitative descriptor of probability (706) and can be adjusted by the user. The probability range (minimum probability 708 and maximum probability 710) is quantitatively expressed in percentages.

In some embodiments, the impact range associated to a scenario (minimum impact 714 and maximum impact 716) can be automatically generated based on the qualitative descriptor of impact (712) and can be adjusted by the user. The impact range (minimum impact 714 and maximum impact 716) is quantitatively expressed in relation to the cost of the corresponding asset. In some embodiments, the impact range (minimum impact 714 and maximum impact 716) is defined using local currency (e.g., Euros or US dollars).

In some embodiments, the computer-generated display of identified scenarios 700 can include multiple control buttons (718, 720 and 722). One control button 718 can be included in the computer-generated display 700 to allow the user to return to the previous step to access the list of identified scenarios. One control button 720 can be included in the computer-generated display 700 to activate the successive step of the scenario-based risk assessment, which enables the display of aggregated scenarios, as described in detail in FIG. 8. One control button 722 can be included in the computer-generated display 700 to allow automatic generation of standard values for the probability and impact ranges for all scenarios.

Referring to FIG. 8, a computer-generated display of information related to the aggregation of evaluated scenarios and determination of the risk probability, impact and maximum risk value algorithm is illustrated. In some embodiments, the aggregation of the evaluated scenarios can be displayed as a bar chart. For example the bar chart could illustrate the impact range 804 as function of probability 802 and/or it could illustrate the impact range 812 as function of risk value 810.

For example, the aggregation of scenarios, could indicate that most probable scenarios (e.g., 95.95% probable) have a low impact (806), while others, which have a lower probability (e.g., 3.89%) can have a higher impact (within 0 to 50 million Euros range) as indicated by 808.

Analyzed differently, as function of risk, the aggregation of scenarios can indicate that scenarios within the impact range between 0 and 50 million Euros have a risk of 972,000 Euros/year, while other scenarios within the impact range between 100 and 150 million Euros have a significantly lower annual risk (27,500 Euros/year), as indicated by 816.

In some embodiments, the computer-generated display of information related to the aggregation of evaluated scenarios 800 can include a control buttons (818) to initiate Monte Carlo experiments (as described in detail with reference to FIG. 3). The computer-generated display of information related to the aggregation of evaluated scenarios 800 can display parameters, relevant to the aggregation of the scenarios (820). For example, the computer-generated display of information related to the aggregation of evaluated scenarios 800 can display the total number of simulations, the number of intervals and considered state of the thread (occurred or not occurred).

A number of embodiments have been described. Nevertheless, it will be understood that various modifications may be made. For example, other methods described herein besides or in addition to that illustrated in FIG. 3 may be performed. Further, the illustrated steps of method 300 may be performed in different orders, either concurrently or serially. Further, steps may be performed in addition to those illustrated by FIG. 3 for risk assessment and some steps illustrated by FIG. 3 may be omitted without deviating from the present disclosure. Accordingly, other embodiments are within the scope of the following claims.

1. A computer-implemented method for managing risks of a business enterprise, the method comprising:
identifying, with a computer system, a threat to a business enterprise;
identifying, with the computer system, based on the threat, a plurality of business enterprise assets and associated impacts;
determining, with the computer system, a plurality of threat scenarios, each threat scenario comprising a minimum and a maximum qualitative probability and a minimum and a maximum qualitative impact;
converting, with the computer system, the minimum and the maximum qualitative probability and the minimum and the maximum qualitative impact of each of the plurality of scenarios to a minimum and a maximum quantitative probability and a minimum and a maximum quantitative impact based on a risk matrix;
determining, with the computer system, a quantitative probability and a quantitative impact by generating random numbers within intervals defined by the minimum and the maximum quantitative probability and the minimum and the maximum quantitative impact;
adjusting, with the computer system, one of the quantitative probability and the quantitative impact based on a threat occurrence;
determining, with the computer system, with a simulation model, a quantitative risk of the identified threat based on the quantitative probability and the quantitative impact; and
preparing, with the computer system, an output comprising the determined quantitative risk of the identified threat for display on a graphical user interface of a computing device.

2. The method of claim 1, wherein the simulation model comprises a Monte Carlo simulation model, and
determining, with a simulation model, a quantitative risk of the identified threat based on the assigned quantitative probability and quantitative impact comprises executing the Monte Carlo simulation model a specified plurality of simulations.

3. The method of claim 2, further comprising receiving, from a user, one or more of:
the specified plurality of simulations for the Monte Carlo simulation model;
a specified number of impact intervals for the quantitative risk; or
a threat occurrence value.

4. The method of claim 3, wherein the determined quantitative risk comprises one or more of a risk probability associated with a particular one of the impact intervals, a monetary impact associated with the particular one of the impact intervals, or a maximum quantitative risk value.

5. The method of claim 1, wherein determining a plurality of threat scenarios comprises correlating one or more of the plurality of business enterprise assets with one or more of the associated impacts.

6. The method of claim 1, further comprising identifying a plurality of asset protection measures, wherein the associated impacts are based, at least in part, on the identified plurality of business enterprise assets and protection measures.

7. The method of claim 1, wherein identifying a threat to a business enterprise comprises receiving, through a form interface, the threat from a business enterprise risk manager, and
identifying, based on the threat, a plurality of business enterprise assets and associated impacts comprises receiving, through the form interface, the plurality of business enterprise assets and associated impacts from the business enterprise risk manager.

8. The method of claim 1, further comprising:
receiving a modification of the assigned quantitative probability from a business enterprise risk manager; and
determining, with the simulation model, a revised quantitative risk of the identified threat based on the modified quantitative probability and the assigned quantitative impact.

9. A non-transitory, tangible computer storage medium encoded with a computer program, the program comprising instructions that when executed by one or more computers cause the one or more computers to perform operations comprising:
identifying a threat to a business enterprise;
identifying, based on the threat, a plurality of business enterprise assets and associated impacts;
determining a plurality of threat scenarios, each threat scenario comprising a minimum and a maximum qualitative probability and a minimum and a maximum qualitative impact;
converting the minimum and the maximum qualitative probability and the minimum and the maximum qualitative impact of each of the plurality of scenarios to a minimum and a maximum quantitative probability and a minimum and a maximum quantitative impact based on a risk matrix;
determining a quantitative probability and a quantitative impact by generating random numbers within intervals defined by the minimum and the maximum quantitative probability and the minimum and the maximum quantitative impact;
adjusting one of the quantitative probability and the quantitative impact based on a threat occurrence;
determining, with a simulation model, a quantitative risk of the identified threat based on the quantitative probability and the quantitative impact; and
preparing an output comprising the determined quantitative risk of the identified threat for display on a graphical user interface of a computing device.

10. The non-transitory, tangible computer storage medium of claim 9, wherein the simulation model comprises a Monte Carlo simulation model, and
determining, with a simulation model, a quantitative risk of the identified threat based on the assigned quantitative probability and quantitative impact comprises executing the Monte Carlo simulation model a specified plurality of simulations.

11. The non-transitory, tangible computer storage medium of claim 10, wherein the operations further comprise receiving, from a user, one or more of:
the specified plurality of simulations for the Monte Carlo simulation model;
a specified number of impact intervals for the quantitative risk; or
a threat occurrence value.

12. The non-transitory, tangible computer storage medium of claim 11, wherein the determined quantitative risk comprises one or more of a risk probability associated with a particular one of the impact intervals, a monetary impact associated with the particular one of the impact intervals, or a maximum quantitative risk value.

13. The non-transitory, tangible computer storage medium of claim 9, wherein determining a plurality of threat scenarios comprises correlating one or more of the plurality of business enterprise assets with one or more of the associated impacts.

14. The non-transitory, tangible computer storage medium of claim 9, wherein the operations further comprise:
identifying a plurality of asset protection measures, wherein the associated impacts are based, at least in part, on the identified plurality of business enterprise assets and protection measures.

15. The non-transitory, tangible computer storage medium of claim 9, wherein identifying a threat to a business enterprise comprises receiving, through a form interface, the threat from a business enterprise risk manager, and
identifying, based on the threat, a plurality of business enterprise assets and associated impacts comprises receiving, through the form interface, the plurality of business enterprise assets and associated impacts from the business enterprise risk manager.

16. The non-transitory, tangible computer storage medium of claim 9, wherein the operations further comprise:
receiving a modification of the assigned quantitative probability from a business enterprise risk manager; and
determining, with the simulation model, a revised quantitative risk of the identified threat based on the modified quantitative probability and the assigned quantitative impact.

17. A system of one or more computers configured to perform operations comprising:
identifying, with the system, a threat to a business enterprise;
identifying, with the system, based on the threat, a plurality of business enterprise assets and associated impacts;
determining, with the system, a plurality of threat scenarios, each threat scenario comprising a minimum and a maximum qualitative probability and a minimum and a maximum qualitative impact;
converting, with the system, the minimum and the maximum qualitative probability and the minimum and the maximum qualitative impact of each of the plurality of scenarios to a minimum and a maximum quantitative probability and a minimum and a maximum quantitative impact based on a risk matrix;
determining, with the system, a quantitative probability and a quantitative impact by generating random numbers within intervals defined by the minimum and the maximum quantitative probability and the minimum and the maximum quantitative impact;
adjusting, with the system, one of the quantitative probability and the quantitative impact based on a threat occurrence;
determining, with the system, with a simulation model, a quantitative risk of the identified threat based on the quantitative probability and the quantitative impact; and
preparing, with the system, an output comprising the determined quantitative risk of the identified threat for display on a graphical user interface of a computing device.

18. The system of claim 17, wherein the simulation model comprises a Monte Carlo simulation model, and
determining, with a simulation model, a quantitative risk of the identified threat based on the assigned quantitative probability and quantitative impact comprises executing the Monte Carlo simulation model a specified plurality of simulations.

19. The system of claim 18, wherein the operations further comprise receiving, from a user, one or more of:
the specified plurality of simulations for the Monte Carlo simulation model;
a specified number of impact intervals for the quantitative risk; or
a threat occurrence value.

20. The system of claim 19, wherein the determined quantitative risk comprises one or more of a risk probability associated with a particular one of the impact intervals, a monetary impact associated with the particular one of the impact intervals, or a maximum quantitative risk value.

21. The system of claim 17, wherein determining a plurality of threat scenarios comprises correlating one or more of the plurality of business enterprise assets with one or more of the associated impacts.

22. The system of claim 17, wherein the operations further comprise:
identifying a plurality of asset protection measures, wherein the associated impacts are based, at least in part, on the identified plurality of business enterprise assets and protection measures.

23. The system of claim 17, wherein identifying a threat to a business enterprise comprises receiving, through a form interface, the threat from a business enterprise risk manager, and
identifying, based on the threat, a plurality of business enterprise assets and associated impacts comprises receiving, through the form interface, the plurality of business enterprise assets and associated impacts from the business enterprise risk manager.

24. The system of claim 17, wherein the operations further comprise:
receiving a modification of the assigned quantitative probability from a business enterprise risk manager; and
determining, with the simulation model, a revised quantitative risk of the identified threat based on the modified quantitative probability and the assigned quantitative impact.
